(19) United States
(12) Patent Application Publication
(10) Pub. No.: US 2007/0008237 A1
(43) Pub. Date: Jan. 11, 2007

(54) Antenna having controllable emission of radiation

(76) Inventors: Amit Mehta, Swansea (GB); Dariush Mirshekar, Colchester (GB)

Correspondence Address: Galgano & Burke;Suite 35, 300 Rabro Drive, Hauppauge, NY, 11788, US

(21) Appl. No.: 11/472,589

(22) Filed: Jun. 22, 2006

(30) Foreign Application Priority Data
Dec. 24, 2003 (GB) 0329934.4
Sep. 22, 2004 (GB) 0421002.7

(51) Int. Cl. H01Q 1/36

(52) U.S. Cl. 343/895

(57) ABSTRACT

An antenna (10) suitable for a mobile telephone or other such communication device has a transmission element (21) to transmit and receive an electromagnetic radiation pattern. The transmission element (21) is supported on a layer or layers (25) of dielectric material, control over the orientation of a radiation pattern to be transmitted or received being maintained electronically. The transmission element (21) includes at least one loop and is often in a spiral configuration. Switches (23, 24) in the form of a microelectromechanical switch or a PIN diode, capable of short or open circuiting the element (21), allow the orientation of the radiation pattern to be altered. The dielectric constant of the dielectric material (25) is variable, again affecting the orientation.

### FIELD OF THE INVENTION

The present invention relates to an antenna with improved capability in locking onto a signal. The antenna is particularly suitable for use as part of a mobile telephone or any wireless device.

### BACKGROUND TO THE INVENTION

The growth in the market for hand-held communication devices, not physically connected to a communication land line has, in recent years, been consistent and large. In particular, mobile telephones are now not only capable of allowing voice communication but also the transmission of moving images, virtually in real time.

As there is no physical connection between a device and a land line, communication or information is transmitted by means of electromagnetic radiation signals. The means to transmit said information is usually an antenna attached to a device. For a device to transmit information, a low power signal is emitted from the device via the antenna. The signal is received by a tower which forwards the signal on. The tower can increase the power of the signal and cause it to be transmitted over large distances. The reception of the signal by a second device is essentially the reverse of the above described process in that a signal transmitted from a tower is received by the antenna of the mobile device and the information carried by the electromagnetic radiation is converted to the form of the output e.g. sound, text, images etc.

Whatever the type of information being communicated, the problem remains of enabling a device to continue in contact with a transmission/reception tower. A key aspect of this is ensuring that the orientation of the signal transmitted by the mobile device is such that it is capable of being received by the tower. If the signal transmitted from the mobile device is not in the direction of the tower then the signal will not be received by the tower, irrespective of the power of the signal transmitted.

In an attempt to overcome this limitation, devices have been produced with a plurality of antennae and a processor to switch between antennae to make sure that the connection is not lost. The disadvantage of this approach is that to include a plurality of antennae increases the complexity of the device and its cost of manufacture.

It is an object of the present invention to provide a single antenna to overcome the above disadvantages and provide an improved device.

### SUMMARY OF THE INVENTION

According to a first aspect of the invention there is provided:

an antenna for use in a communication device;

the antenna having a transmission/receiving element, the element being adapted to transmit and receive a radiation pattern;

the element being supported on a dielectric material layer;

wherein the orientation of a radiation pattern transmitted or able to be received by the element is controlled electronically.

The antenna is simpler and cheaper to manufacture than conventional antennae. The need to include complex electronic circuitry (such as phase shifters and their associated control) to activate and deactivate antenna elements as in the case of a multiple element antenna system is therefore obviated.

The transmission/receiving element preferably includes at least one loop. An element having a spiral configuration is particularly preferred with a rectangular spiral being especially preferred. Alternatively, the spiral can have, a circular, triangular, trapezoidal configuration.

Conveniently, dielectric material from which the layer is formed dielectric material has a dielectric constant of from 2-10. Typically the value is from 3.4-3.9. Preferably the thickness of the dielectric material layer is less than 20 mm, and particularly preferably 10-14 mm. The dielectric material layer optionally comprises two layers of dielectric materials of different dielectric constant.

Conveniently the dielectric material layer is itself supported on a conductive layer, the conductive layer being itself optionally backed by an insulating medium.

The use of at least one low loss radio frequency (RF) switch (for example micro electromechanical switch (MEM) or PIN diode) will introduce phase shifts in the signal travelling on the transmission element by shorting or open-circuiting the element. This has the effect of changing the radiation pattern of the antenna. Hence the radiation pattern can be made adaptive by using multiple switches.

Advantageously the dielectric constant of one or both of the dielectric material layers is variable. Variation of the dielectric constant can be by means of an applied d-c voltage which causes a change in the dielectric constant of the dielectric material. Since the guided wavelength along the spiral arm is dependant on the value of the dielectric constant, changing the dielectric constant causes a change in the angle of the emitted beam. Particularly preferably the applied voltage is from 5-50V with 5-20V being especially preferred. Optionally, a liquid crystal is embedded within the dielectric material. Variation of the magnitude of the applied voltage therefore causes a change in the angle of an emitted beam of radiation, and allows very rapid switching without the use of moving parts or continual breakage and formation of a circuit. The communication device can therefore readily transmit in the direction required to remain in contact with a receiver.

According to a second aspect of the invention there is provided a communication device, the device including an antenna including a transmission element having at least one loop, the device further including one or more switches to effect a break in the transmission element. Preferably, the transmission element has a spiral configuration.

### BRIEF DESCRIPTION OF THE DRAWINGS

The invention will now be described with reference to the accompanying drawings which show by way of reference two embodiments of an antenna element of a communication device. In the drawings:

FIG. 1 illustrates the emission of electromagnetic radiation from a mobile phone;

FIGS. 2A and 2D illustrate two views of an antenna;

FIGS. 3A and 3B illustrate the beam emitted or received by the antenna of FIG. 2 and a standard antenna respectively;

FIG. 4 illustrates an open circuit switch antenna arm; having four open switches;

FIG. 5 is a table illustrating switching configurations of the antenna arm in FIG. 4;

FIG. 6 is an x-y plot showing θₘₐₓ and φₘₐₓ for the switching configurations in FIG. 5.

FIGS. 7 and 8 show the gain and the VSWR respectively for the switching configurations of FIG. 5;

FIG. 9 illustrates the radiation pattern for the maximum beam directions for switch configurations 4 and 13 shown in FIG. 5;

FIG. 10 illustrates an antenna having four shorting switches;

FIG. 11 is an x-y plot showing θₘₐₓ and φₘₐₓ for shorting switch configurations in FIG. 5.

FIGS. 12 and 13 show the gain and the VSWR respectively for shorting switch configurations of FIG. 5;

FIG. 14 illustrates the radiation pattern for the maximum beam directions for shorting switch configurations 4 and 13 shown in FIG. 5;

FIG. 15 illustrates an antenna having a dielectric layer of varying dielectric constant; and

FIG. 16 is a x-y plot of θₘₐₓ and φₘₐₓ against dielectric constants

### DETAILED DESCRIPTION OF THE INVENTION

The following example is one embodiment of the invention. It will of course be understood that there are a number of ways of incorporating the invention which do not depart from the inventive concept.

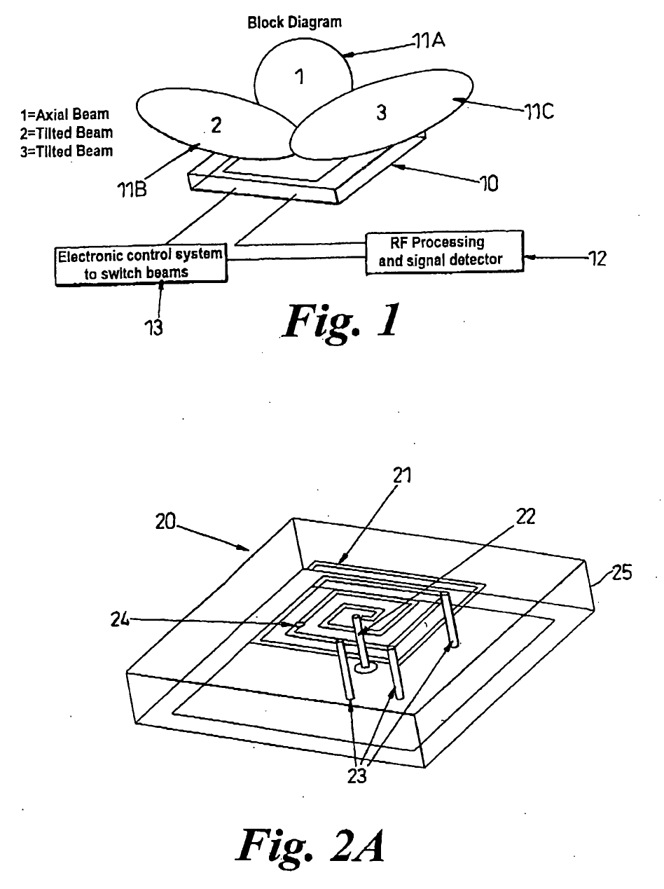

In FIG. 1, an antenna 10 which emits a signal in the form of a beam of electromagnetic radiation. The beam is capable of carrying sufficient information for a decoding device to reproduce sound, text or visual images. The beams 11A,B,C are inclined at different angles relative to each other. The angle of the beam is variable and thus beams 11A,B,C are just illustrative examples. This feature maximises the possibility of the element either transmitting to a tower or alternatively receiving a message therefrom.

In determining the angle of the beam to be used, a processing and signal strength detector 12 monitors the strength. Should the detector 12 determine the need to transmit using a different beam 11, the detector 12 sends a signal to a circuit 13 which controls the direction of the beam 11.

The circuit 13, should it be so-required, switches the angle of the beam 11 so as to orient it towards the direction of the strongest signal. In this manner contact with a transmission tower is maintained and kept strong.

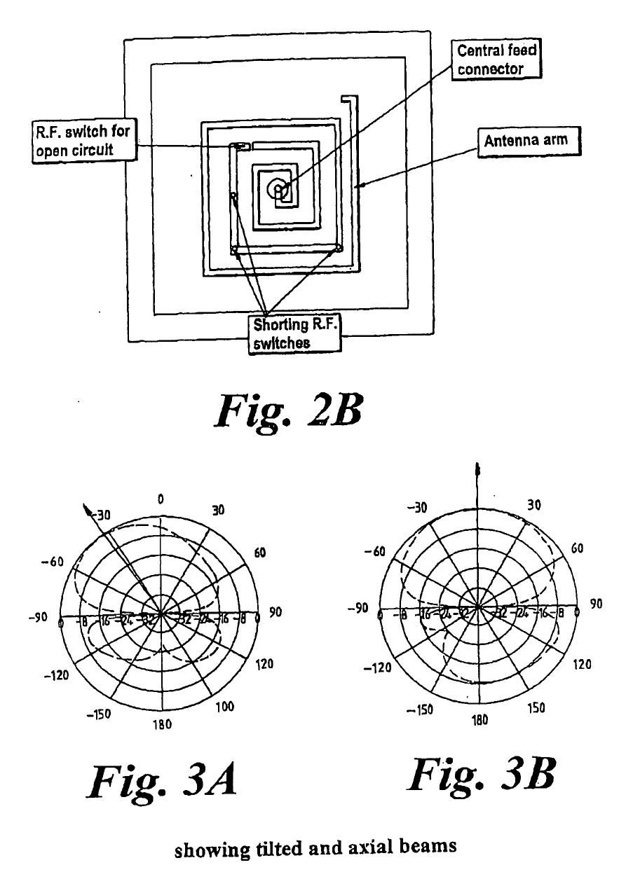

An embodiment of an antenna suitable to emit the beam pattern of FIG. 1 is shown in FIG. 2A. In FIG. 2A, the antenna 20 has a copper transmission element 21 having the form of a single-armed, rectangular spiral. The transmission element 21 is approximately 1.4 mm wide and has an overall length of approximately 290 mm. A support 25 for the transmission element 21, is made of a dielectric material, Roger Ro-4350B having a dielectric constant of approximately 3.7. In order to produce a good signal the antenna's thickness is approximately 12 mm. For convenience the dielectric material is formed into a square having a side length of approximately 51.3 mm.

The dielectric material, itself is backed by a conducting plane and where useful, for example to improve ease of incorporation of the antenna within a device, the conducting plane itself can be backed by a further layer formed of electrically insulating material.

One of the functions of the transmission element 21 is to emit, upon energisation by an electric current, a beam of electromagnetic radiation, carrying information. The point 22 is the feeding point of the antenna 10. Shorting RF switches 23 and open circuit switch 24 are used to introduce a phase shift in the signal travelling on the antenna arm. The phase shift effects a movement in the angle of the beam radiated from the antenna. With the use of multiple switches any desired variation in the angle of the beam radiated can be achieved. Thus, making the whole of the antenna radiation pattern adaptive.

The dielectric constant of the dielectric material from which the support 25 is made will typically have a dielectric constant of from 2-10. It has been found that a range of 3.4-3.9 for the dielectric constant gives an efficient and effective antenna. A number of materials known in the art, therefore suggest themselves as being suitable for use.

The thickness of the antenna 20 produced depends on a number of factors such as the operating frequency, the dielectric material used, the impedance of the feeding point and the dimensions of the unit into which the antenna is incorporated. For example, the usage of a material, for the support, which has a higher dielectric constant enables a thinner antenna to be used. Antenna contemplated in the present invention have a thickness of less than 20 mm. More typically the thickness of an antenna can be 10-14 mm.

Different shapes are possible for a transmission element whilst retaining at least one substantially 360° turn within the configuration. Although the use of a rectangular spiral allows easier numerical analysis of the signal, a circular spiral, trapezoidal or a triangular transmission element can be used.

In order to provide a switching function, a switch which allows both rapid switching and which is robust is required. In practice such a switch is provided by a microelectromechanical switch (MEMS), a pin diode or any radio frequency (RF) switch. In use, the particular type of switch is chosen to suit the particular dimensions of the antenna.

It has been found useful to be able to perform small changes of the angle of an emitted beam. In one embodiment, illustrated in FIG. 2A. This has been achieved by introducing a number of breaks of circuit within the spiral arm of the transmission element. Such breaks are provided by means of switches. As can be visualised, the circuit can be made shorter or longer in a series of finite steps by activation or deactivation of the switches. By controlling which switches are open and closed, the angle of beam emission is thereby altered as and when required. It will be appreciated that increasing the number of switches incorporated into an antenna arm, decreases the lengths of the steps between the different effective lengths of the antenna. A greater number of switches therefore can lead to a smoother change in the angles at which radiation is emitted.

An example of the change induced in a transmitted beam is given in FIGS. 3A, 3B, in which the arrows indicate the direction of maximum emitted radiation. In FIG. 3B the emitted radiation is predominantly axial, that is directed along the axis vector of the spiral. On application of the switches, the vector is rotated so that its direction is no longer in line with said axis vector.

On using the switching antenna as described above it has been found that the Voltage Standing Wave Ratio (VSWR), which is a measure the ratio of forward power to reflected, power, normally remains under 2, indicating that the power required to transmit a signal is not greatly affected by switching. For the limited number of switch configurations where the VSWR value rises above 2, extra power can be channelled to signals to ensure signal stability. The gain for various configurations is relatively constant at around 7.5 dB+/−1.5 dB.

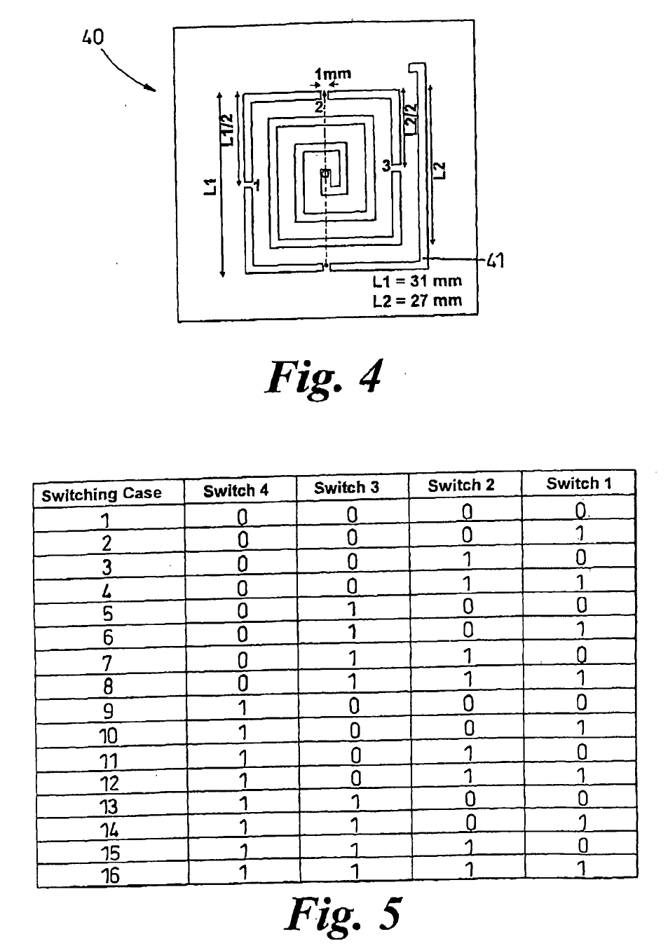

FIG. 4 illustrates an antenna 40 having a series of open circuit switches indicated at 1, 2, 3, and 4. The switches are approximately 1 mm wide and their operation acts to shorten or lengthen the effective length of the antenna arm 41.

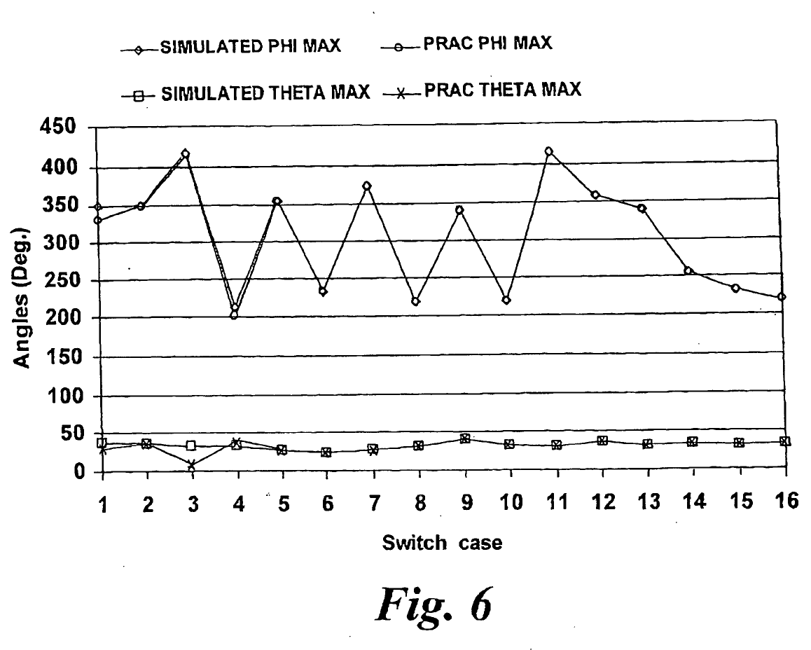

The effect of activating the switches is shown in FIGS. 5-9. As in the exemplified disclosure, there are 4 switches, each of which can be either in an on or off position, there are essentially 16 different combinations or switching configurations, and hence 16 effective lengths of antenna are possible. The 16 switching configurations are shown in the table in FIG. 5. FIG. 6 shows the θₘₐₓ and φₘₐₓ values obtained with the various switch configurations given in FIG. 5. The largest variation is seen to be in φ_{max,} with a relatively small variation θₘₐₓ. The second sets of lines indicate results obtained from theoretical predictions φₘₐₓ and θₘₐₓ and it can be seen that there is relatively good correlation between theory and experiment.

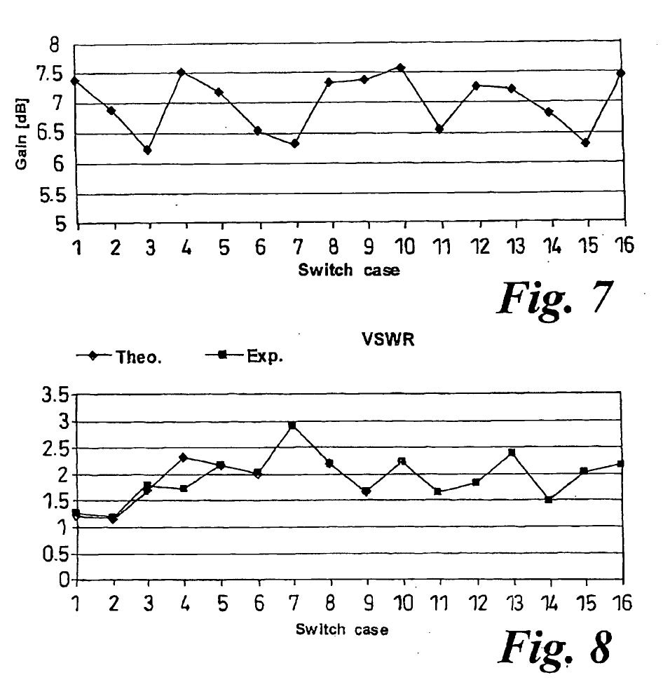

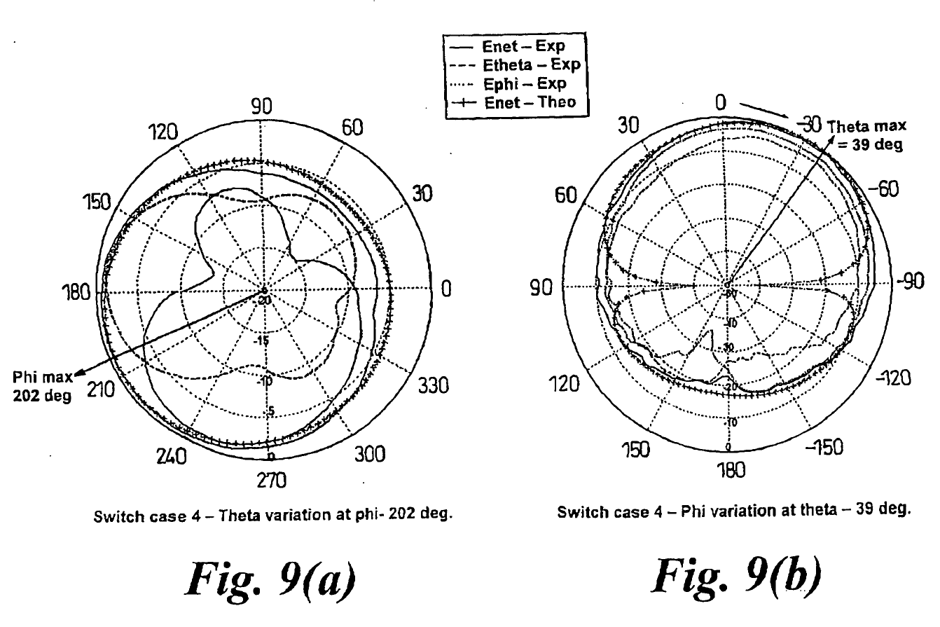

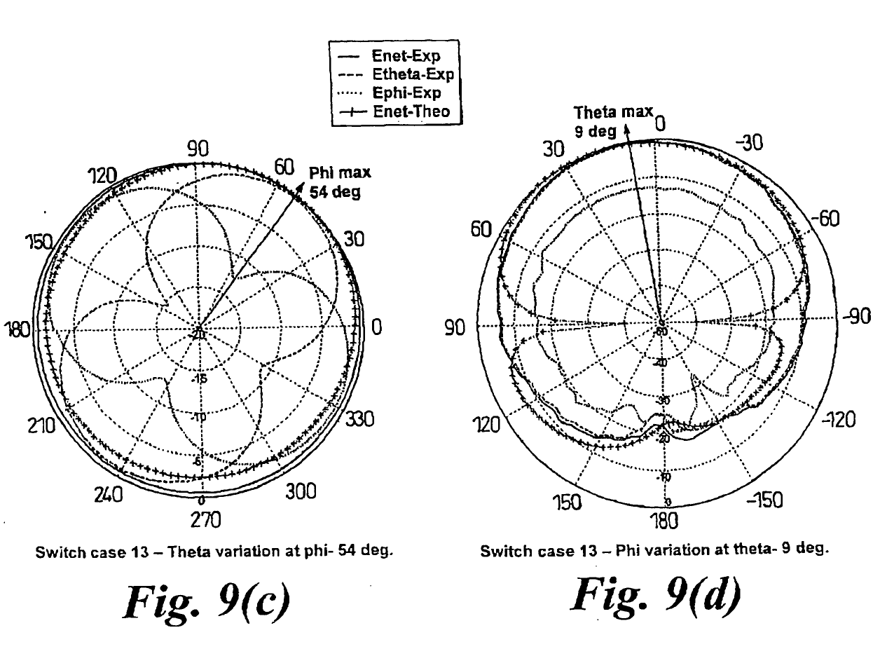

FIG. 7 shows the gain (in dB) for the various switch configurations. The VSWR is given in FIG. 8 and shows that for the majority of switch configurations, the VSWR is below 2. Finally, the radiation patterns in the directions of the maximum beam for switch configurations 4 and 13 respectively are shown in FIG. 9.

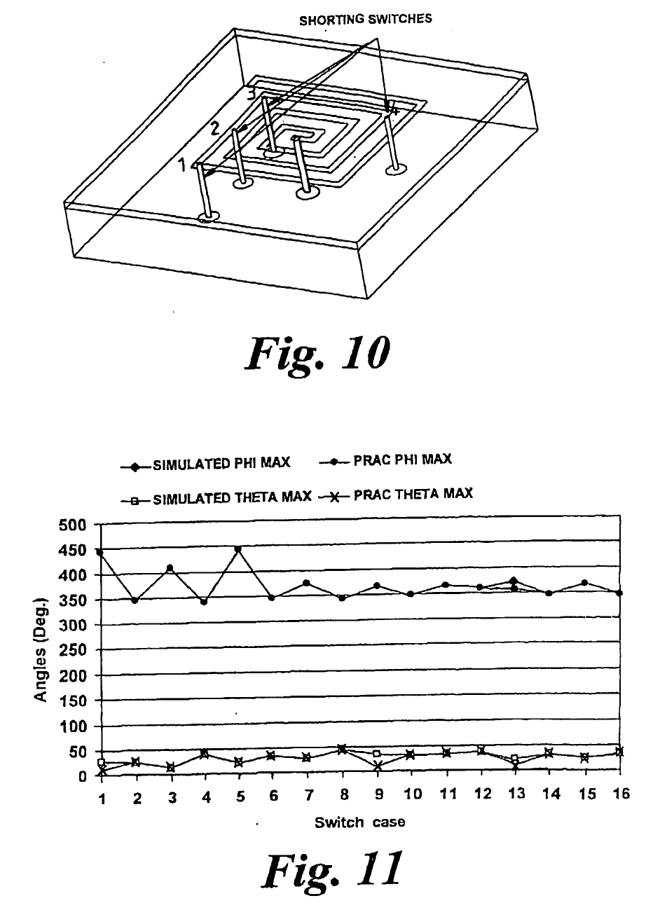

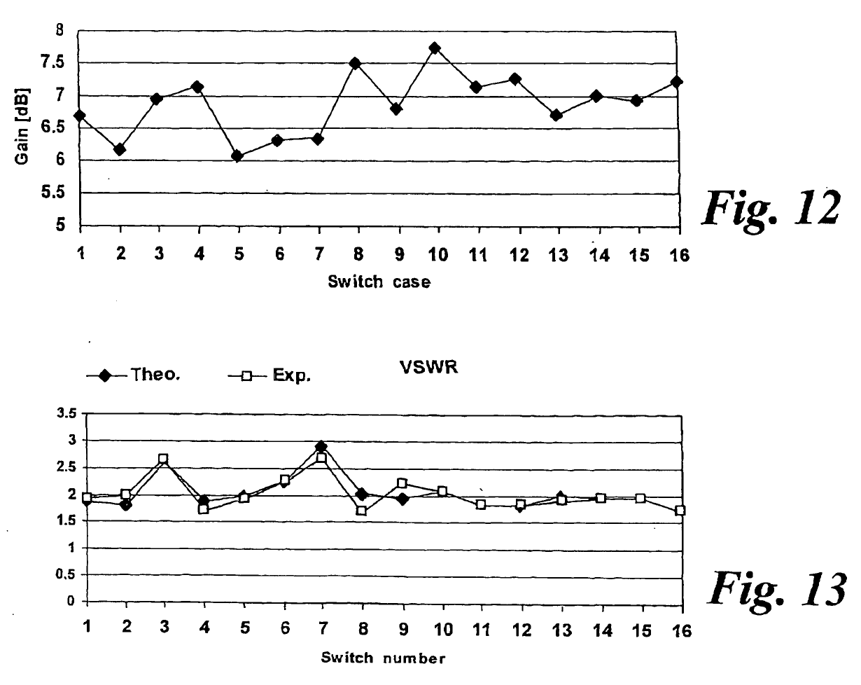

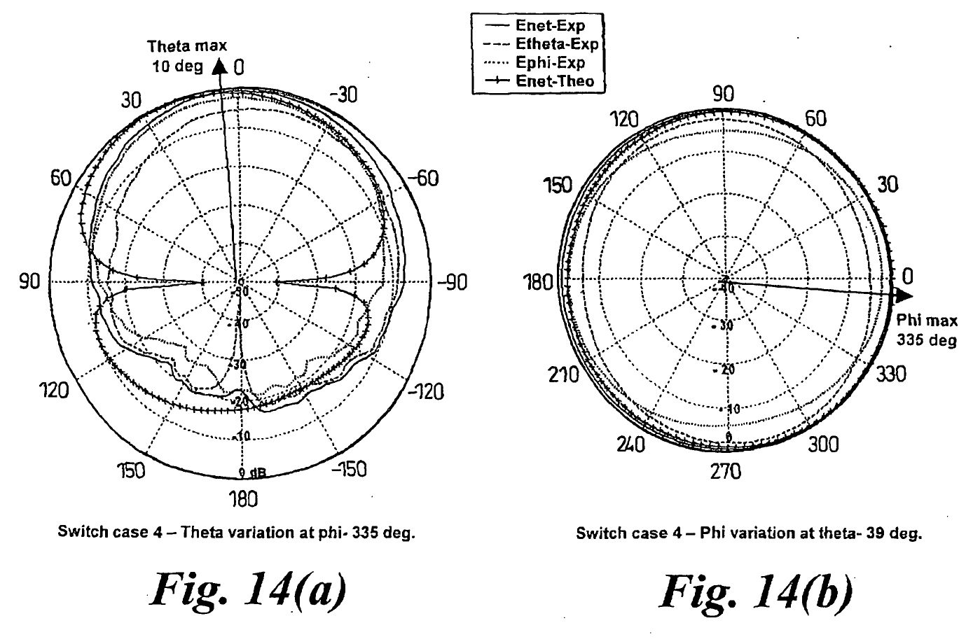

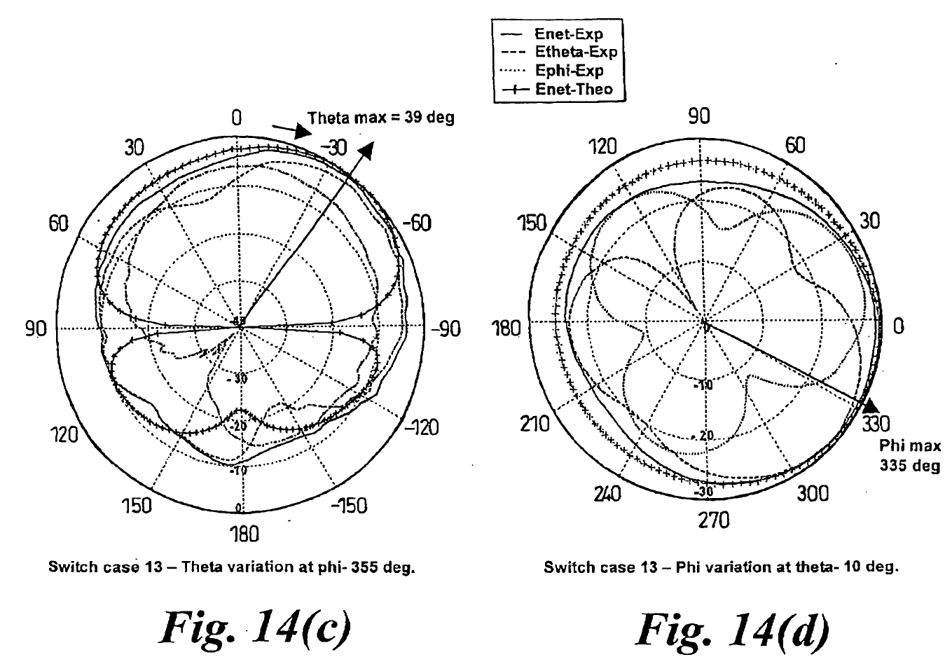

FIGS. 10-14 illustrate results for the shorting switch mode of operation. The switch configurations are those shown in FIG. 5.

In a further embodiment of an antenna, the direction of the emitted beam is altered by applying a d-c voltage across the support from the transmission element to the conducting plane. A typical applied voltage is from 5-50V, with a range of from 5-20V being preferred. Application of the voltage changes the dielectric constant of the support material which alters the emitted beam's angle. In an aspect of this embodiment, a liquid crystal is embedded in the substrate material itself. Variation of the voltage across the liquid crystal then causes the dielectric constant to change.

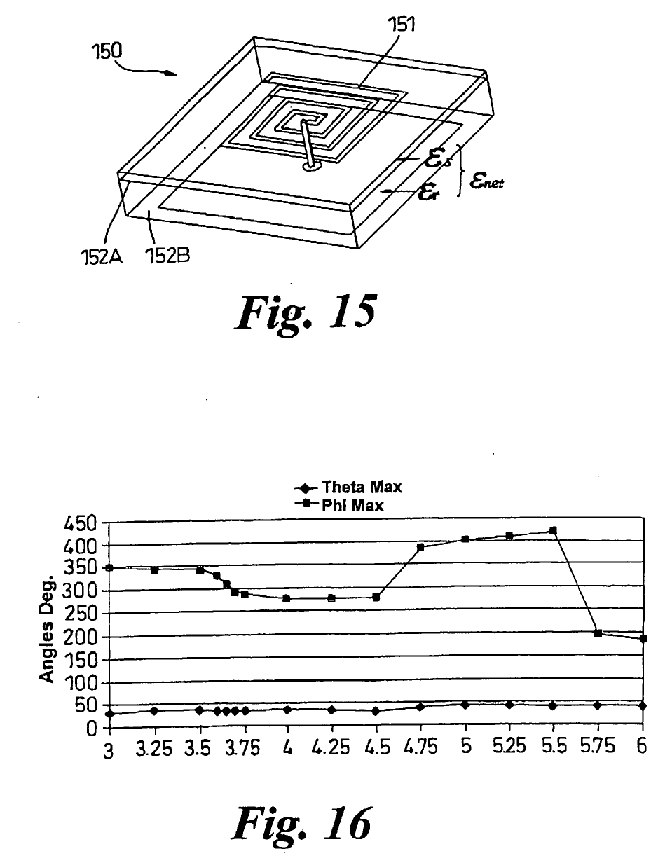

For an example of such a device is shown in FIG. 15. The antenna 150 has a transmission element 151 which, as previously, is in the form of a rectangular, single-armed spiral. The dielectric substrate on which the element 151 lies comprises two layers 152A, 152B which are of differing dielectric constant ∈ₛ and ∈ᵣ respectively. Typically the layer 152A is formed of a synthetic/ferro-electric material. Application across the antenna therefore of a voltage V causes the dielectric constant ∈ₛ of the material on the layer 152A to change. The net dielectric constant of combined dielectric layers, ∈ₙₑₜ is a function of ∈ₛ and ∈ᵣ. Changing ∈ₛ therefore changes ∈ₙₑₜ and causes the effective guided wave length λ_{g} within the element 151 to be altered and thereby the angle at which radiation is emitted from the antenna.

FIG. 16 illustrates the effect of changes of dielectric constant on the angle of transmission. In FIG. 16, the axial and radial (with respect to the spiral transmission element) components of the transmitted radiation have been separated and are designated by θₘₐₓ and φₘₐₓ respectively. It will be noted that as ∈ₙₑₜ is changed then the angles of θₘₐₓ and φₘₐₓ are also changed. Across the illustrated ∈ₙₑₜ values, θₘₐₓ exhibits a variation of 19° and φₘₐₓ a variation of 237°. This compares with a range of 39° and 174° for the switching method illustrated earlier. Thus the switching method is capable of inducing greater variations in θₘₐₓ and changing the dielectric constant induces greater variations in φₘₐₓ. It can be envisaged that a combination of the switching method and the dielectric method can be used to bring about the widest variations of both θ and φ within a single device.

It will of course be understood that the invention is not limited to the specific details described herein, which are given by way of example only, and that various modifications and alterations are possible within the scope of the appended claims.

1. An antenna for use in a communication device comprising:
a transmission element, the element being adapted to transmit and receive a radiation pattern;
the transmission element being supported on a dielectric layer of dielectric material;
wherein the orientation of a radiation pattern transmitted or able to be received is controlled electronically.

2. An antenna according to claim 1, wherein the transmission element includes at least one loop.

3. An antenna according to claim 1, wherein the transmission element has a spiral configuration.

4. An antenna according to claim 3, wherein the transmission element has a rectangular spiral configuration.

5. An antenna according to claim 3, wherein the spiral is of circular, triangular, trapezoidal configuration.

6. An antenna according to claim 1, wherein the dielectric layer has a dielectric constant of from 2-10.

7. An antenna according to claim 6, wherein the value of the dielectric constant is from 3.4-3.9.

8. An antenna according to claim 1, wherein the thickness of the dielectric layer is less than 20 mm.

9. An antenna according to claim 8, wherein the thickness of the dielectric layer is 10-14 mm.

10. An antenna according to Clam 1, the antenna including at least one low loss radio frequency switch which short or open circuits the element, thereby changing the orientation of the radiation pattern of the antenna.

11. An antenna according to claim 10, where in said at least one switch is a microelectromechanical switch or a PIN diode.

12. An antenna according to claim 1, wherein the dielectric layer comprises at least two layers of dielectric materials of different dielectric constant.

13. An antenna according to claim 12, wherein each of said layers of dielectric material is itself supported on a conductive layer.

14. An antenna according to claim 13, wherein each said conductive layer itself is backed by an insulating medium.

15. An antenna according to claim 1, wherein the dielectric constant of the dielectric material is variable.

16. An antenna according to claim 1, wherein a d-c voltage is applied across the dielectric material thereby altering the dielectric constant of said material.

17. An antenna according to claim 16, wherein the applied voltage is from 5-50V.

18. An antenna according to claim 17, wherein the applied voltage is from 5-20V.

19. An antenna according to claim 1, wherein a liquid crystal is embedded within the dielectric material.

20. A communication device, including an antenna having a transmission element having at least one loop, the device further including at least one switch to effect a break in the transmission element.

21. A device according to claim 20, wherein the transmission element has a spiral configuration.

22. (canceled)
